(19) United States
(12) Patent Application Publication
(10) Pub. No.: US 2001/0024610 A1
(43) Pub. Date: Sep. 27, 2001

(54) Lift truck or an attachment for a lift truck incorporating a rotating device

(76) Inventor: Wilhelm Schmidt, Wallmoden-Bodenstein (DE)

Correspondence Address: Jodi-Ann McLane, Salter & Michaelson, 321 South Main Street, Providence, RI, 02903-7128, US

(21) Appl. No.: 09/812,377

(22) Filed: Mar. 20, 2001

(30) Foreign Application Priority Data
Mar. 20, 2000 (DE) 100 13 359.2

(51) Int. Cl. B66F 9/18

(52) U.S. Cl. 414/620; 414/911

(57) ABSTRACT

A lift truck or an attachment for a lift truck incorporating a rotating device with which loads are to be transported on or between receiving elements, particularly between two clamping jaws (15), whereby said loads can be held in various orientations, is characterised in that the rotating device (30) is rotatable in both directions and by more than 180°, in that a hydraulic fluid (31) is provided for the drive means for producing the rotary movement, in that one or more cam members (40) are arranged on the rotating member of the rotating device (30), in that one or more elements (41) are arranged on the fixed parts of the lift truck (10) or the attachment (14) opposite the rotating device (30) at those particular locations through which the cam member (40) or the cam members on the rotating device (30) pass shortly before the arrival thereof at the two vertical positions of the rotating device, in that the cam members (40) thereby actuate the elements (41) and in that a signal is produced by virtue of this actuation for cutting off the pressure exerted by the hydraulic fluid on the drive means in this direction of rotation.

The invention relates to a lift truck or an attachment for a lift truck incorporating a rotating device with which loads are to be transported on or between pickup elements, particularly between two clamping jaws, whereby said loads can be held in various orientations. The device can be used especially for an attachment for lift trucks. Furthermore, the invention relates to a method of controlling a rotating device.

Amongst other things, paper reels are transported by front leaders and the attachments mounted thereon. This form of transportation is made use of in paper manufacturing plants for example, or when further processing the paper, for example in a newspaper publishing plant, and especially too, in temporary storage locations, such as in harbours. There, the paper reels have to be transported to-and-fro between warehouses, ships, lorries and quayside installations. Hereby, they are frequently arranged perpendicularly, i.e. with vertically aligned cylindrical axes. However, there are other situations in which the paper reels have to be laid flat i.e. with horizontally aligned cylindrical axes. Moreover, the need may arise for a vertical disposed paper reel to be turned completely upside down since, for various reasons, it may be necessary for a particular end thereof to be at the top or the bottom.

Furthermore, it is sometimes imperative that the paper reel be held vertically during the transportation thereof, for example when passing through very narrow passages, as otherwise it might touch posts or walls disposed at the sides of the passageway. Contrariwise, it may also happen that a horizontal disposition of the paper reel on the lift truck is desirable for traversing through very low passages so that a very long paper reel will not strike the upper surface of the passage when passing therethrough.

It is for this reason that so-called rotating devices are provided ab initio on the lift trucks or their attachments. These rotating devices are capable of rotating the whole load together with the clamping jaws or the other receiving elements about a horizontal rotational access, usually, about an axis whose orientation is parallel to the longitudinal axis of the lift truck. This axis is thus perpendicular to the cylindrical axis of the paper reel or any other cylindrical load.

Paper reels are very delicate. In the case of a vertically oriented cylindrical axis, it is imperative that steps be taken to prevent them being placed on the ground with other than exact vertical alignment. If there is an angle of just a few degrees between the cylindrical axis and the direction in which it is being set down, then the paper reel will be set down obliquely whereby a lower edge of the paper reel will be subjected to point-like forces which can lead, virtually immediately, to the reel being deformed and/or to the reel being despoiled in this region. It should also be borne in mind that paper reels can be extremely heavy.

For these reasons, such rotating devices are generally designed such as to have a pivotal angle of exactly 180°. This enables them to set the reel down vertically at one end position of their pivotal movement, or to place the same paper reel such that it is completely upside down in the other end position of the same pivotal motion. These end positions thereby simultaneously clearly define the positioning required to avoid wrong placement. The horizontal arrangement is somewhat less critical and can be signified by means of a suitable marking which is visible to the driver of the lift truck.

Lift trucks of this type having a so-called 180° rotating device are in common use. They are usually operated by a rack and pinion type mechanism which enables a rotation to be made between these two end points. However such 180° rotating devices have the disadvantage that they are restricted to this one application of use so that even the relevant drive means and various other devices have to be specially set therefor.

There are also 360° rotating devices which enable the loads held thereby to be rotated in any direction as often as necessary. This gives the driver of the lift truck substantially more freedom to rotate his load during the transportation thereof by the precise amount he deems most appropriate when passing through narrow locations, passageways, etc. This is also required for certain types of load which, in certain forms, have to be placed in or inserted into specific positions. The disadvantage of these 360° rotating devices is that the defined placement of cylindrical paper reels as explained above cannot be absolutely guaranteed since they are reliant upon the powers of assessment of the driver of the lift truck or upon the attention he pays to particular markings within his field of view. Since this frequently does not happen to a sufficiently satisfactory extent, these 360° rotating devices are not accepted in many instances, particularly in the field of harbour installations.

Attempts to convert such a 360° rotating device so that it could only be moved between two maximum end stops simply by adding artificial mechanical stops, were not successful. The mechanical end stops led to very rapid wear and tear and to damage to the entire mechanism and the attachment. Nevertheless, it would be useful if 360° rotating devices could be used for these special purposes without alteration.

Consequently, the object of the invention is to propose a device for and a method of controlling the rotating devices in lift trucks which would enable cylindrical paper reels to be set down exactly vertically in a reliable manner and without the danger of premature wear and tear even in the case of a 360° rotating device.

In the case of a device in accordance with the invention, this object is achieved in that the rotating device is rotatable in both directions and by more than 180°,

in that a hydraulic fluid is provided for the drive means for producing the rotary movement,

in that one or more cam members are arranged on the rotating member of the rotating device,

in that one or more elements are arranged on the fixed parts of the lift truck or the attachment opposite the rotating device at those particular locations through which the cam member or the cam members on the rotating device pass shortly before the arrival thereof at the two vertical positions of the rotating device,

in that the cam members thereby actuate the elements and in that a signal is produced by virtue of this actuation for cutting off the pressure exerted by the hydraulic fluid on the drive means.

Surprisingly, the problem can be completely solved thereby. A known rotating device, which is arbitrarily rotatable in both directions but in any case by more than the conventional 180° rotating devices, is employed. A hydraulic drive means is employed. If the driver of the lift truck now moves the rotating device towards the vertical position, then it would be technically possible for the rotating device to move beyond the end points. Although the driver is also participating in appropriately controlling the rotationional process, a form of forced cut-off is undertaken here. This occurs in that shortly before reaching the sought for end position, a part of the rotating device incorporating a cam member encounters an element, for example a probe or a sensing pin or some other device, thereby setting up an interaction therewith which, for its part, cuts off the pressure exerted by the hydraulic fluid on the drive means. As a result of such a cut-off, the rotational movement is not then braked abruptly as happens when striking a stop, but simply by virtue of the ensuing coasting process since the hydraulic fluid is no longer producing a pushing effect.

Consequently, practically every form of mechanical stress, which has led to damage and to the unreliability of the device in the previous attempts, is thereby removed. Nevertheless, the effect is achieved that further rotation is reliably interrupted precisely at the wanted position. The cut-off process could be produced by appropriately actuating a valve, by means of which, the pressure is then simply removed even though the driver might still be trying to maintain the pressure via his control lever.

Nonetheless, since the hydraulic drive means functions in both directions, rotation in the opposite direction from this end cut-off position can be effected immediately. After all, it is not really switched off, it is merely that the pressure has been removed in one of the two directions of rotation.

Naturally, the driver will establish that he has reached the end position and can react accordingly. It is not necessary to move slowly and delicately forward, nor is great concentration required although this would naturally be contributory to carrying out the job and the rotation process more quickly.

No great demands are made on the mechanisms employed, they can be used in the roughest of conditions, and they are reliable, economical and require little maintenance.

Due to the simple installation of a cam member and the oppositely located cut-off mechanisms, a 360° rotating device can be reliably equipped such that it functions like a 180° rotating device and will come to rest precisely at the desired end points; this being done without mechanical wear and tear.

From a technical viewpoint, the use of just one cam member would be sufficient; however, for additional security, a plurality of suitably distributed cam members together with the corresponding elements are employed.

It is preferable that the rotating device be in the form of a 360° rotating device. As already mentioned, such rotating devices are particularly reliable and their construction has proved its worth in other contexts.

The previously described functions of the cam members and the elements could be interchanged. That particular one of the two partners in this pair that is disposed on the rotating part of the rotating device would then provide the cut-off signal. However, the version preferred is the one where the signal emitter is located on the stationary part.

In a particularly simple and reliable embodiment, the signal could also be in the form of a direct actuation of a pin in a valve.

The invention is not restricted to the employment of lift trucks and attachments for the transportation of paper reels. It is also possible for other concepts of clamping jaws to be so equipped. Moreover, such devices, as are used to transport containers whose contents should be emptied at predetermined positions whereby a rotating device might likewise be employed, could also be equipped correspondingly. Other forms of attachment could also be constructed or converted in a corresponding manner.

Moreover, the invention provides an additional function which 180° rotating devices do not have.

Namely, in one preferred embodiment, it is possible to re-establish the functionality of a 360° device by means of a manual actuation. To this end, it is merely necessary to switch over a valve which then takes the aforesaid cut-off process away from the normal hydraulic circulation system.

The following possibility ensues from this feature:

In many instances, the ground in the harbour installations, a quay installation or perhaps a ship that is being loaded, is not completely even and horizontal in comparison to the lift truck which is carrying the load that is to be set down. However, merely a slight inclination to the ground of just a few degrees in those cases where one is trying to set down the load such that it is preferably vertical, would cause just such forms of damage that, as was mentioned hereinabove, ought to be avoided. Thus, the case could occur wherein an exact rotability of 180° is not really wanted.

Now when a rotation of somewhat less than 180° is desired, although conventionally difficult, it is still possible. This could be done by means of a precise control process. However, should it now be established that the setting down process cannot be achieved in an optimal form even in suchlike manner, this is practically impossible with conventional 180° rotating devices and leads at least, to a very complicated shunting process.

By contrast however, in accordance with the preferred embodiment of the invention, an auxiliary switch is actuated again after reaching the cut-off position for the hydraulic drive means, said switch enabling a carefully controlled renewed actuation of the hydraulic drive means so that a few additional angular degrees can then be provided in a controlled manner.

Thus, in accordance with the invention, it would be possible to implement all the advantages of the two forms of drive systems in one and the same device, namely, at practically no extra cost.

An embodiment of the invention will be explained in detail hereinafter with the help of the drawings. Therein

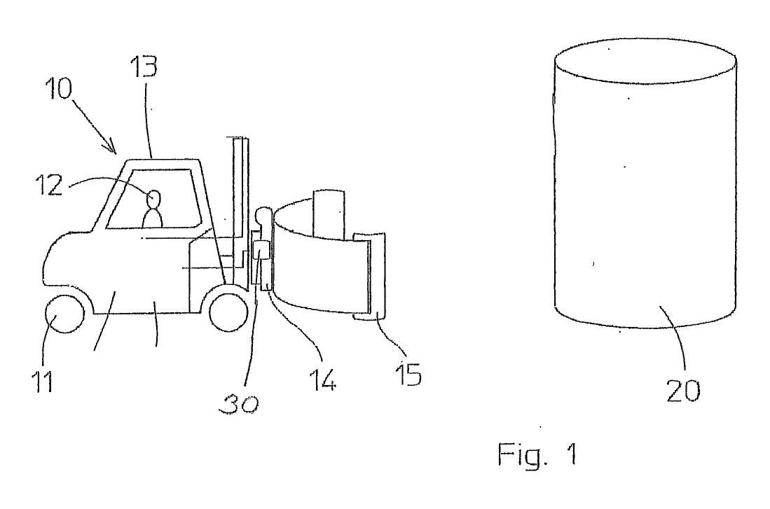

FIG. 1 shows a schematic drawing of a lift truck holding a load that is to be transported;

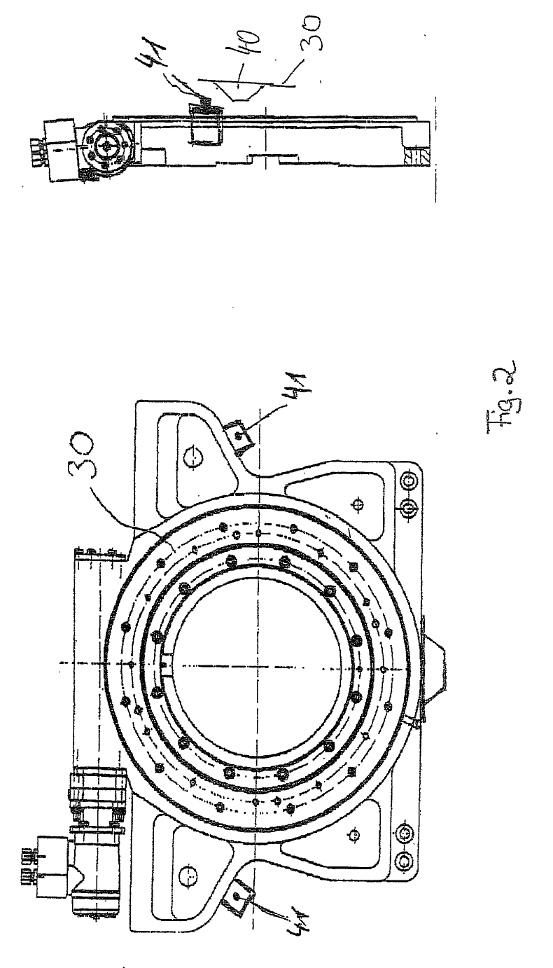

FIG. 2 a view of a rotating device;

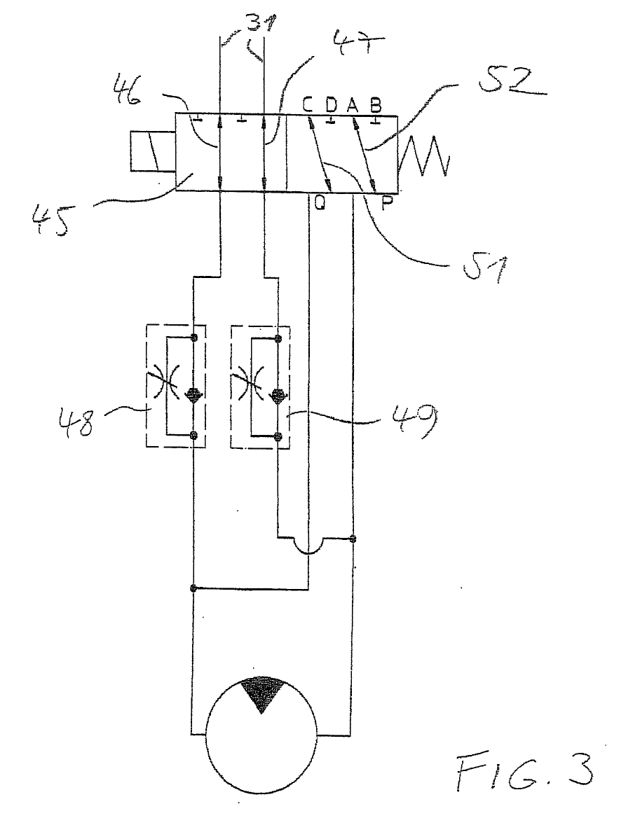

FIG. 3 a circuit diagram for a preferred embodiment of the hydraulic circuit.

A lift truck 10 is illustrated in purely schematic manner in FIG. 1, wherein two wheels 11 and a notional driver 12 under a roof 13 of the lift truck 10 can be perceived.

An attachment 14 incorporating clamping jaws 15 is disposed on the lift truck.

The lift truck 10 moves on its wheels 11 in order to transport the loads that are disposed between the clamping jaws 15. The attachment 14 provides for the to-and-fro movement of the clamping jaws 15 which enables a load located therebetween to be securely retained or released for unloading purposes.

In the embodiment illustrated, the lift truck 10 is provided for the purposes of transporting a load 20, here, a paper reel. This paper reel may have very considerable dimensions and is cylindrical.

The clamping jaws 15 and the load 20 carried therebetween should then be rotatable about a horizontal axis which extends in parallel with the longitudinal axis of the lift truck 10 and perpendicularly relative to the axis of the cylinder of the load 20. To this end, the attachment 14 is equipped with a rotating device 30 which is indicated in purely schematic manner in FIG. 1.

The rotating device 30 together with diverse details of the attachment 14 is illustrated in more detail in FIG. 2. The rotatable parts are shown in bold lines, the non-rotatable parts of the rotating device 30 which are mounted on the lift truck are shown in less bold lines.

Two non-rotating elements 41, which are encountered by a rotating cam member 40, are only illustrated in a very schematic manner. These elements 41 are switches. If, in the course of a rotation, one element 40 [sic] is touched or otherwise actuated by the cam member 40 then the supply of hydraulic fluid 31 is cut-off and the rotation comes to an end even if the driver 12 of the lift truck 10 deliberately or unintentionally wants to cause the rotation to continue.

A schematic symbolic diagram according to DIN 24300 is shown in FIG. 3. A valve 45 lies at the heart of the illustration. Altogether, this has four passages. Two passages out of these four passages are adapted to be opened on each occasion by a switching action. Each one of these two pairs comprises one passage for rotation to the left and one passage for rotation to the right.

The two passages 46 and 47 that can be perceived to the left of the illustration extend downwardly, as seen in the illustration, to a respective closure valve 48 and 49. The cut-off process carried out by the elements 41 is effective here. The cut-off process is only effective in respect of one direction of rotation on each occasion; in the opposite direction, the stream of hydraulic fluid 31 continues to flow so as to ensure an immediate start in said opposite direction.

The drive means is illustrated symbolically below.

The two passages 51 and 52 at the right hand side of FIG. 3 are not open in this illustration. They can be brought into operation by manual actuation, in place of the passages 46 and 47, thereby ensuring a further supply of hydraulic fluid 31 which is unaffected by the elements 41.

### LIST OF REFERENCES

10 lift truck

11 wheels

12 driver

13 roof

14 attachment

15 clamping jaws

20 load, for example, paper reel

30 rotating device

31 hydraulic fluid

40 cam member

41 elements

45 valve

46 passage

47 passage

48 valve

49 valve

51 passage

52 passage

1. A lift truck or an attachment for a lift truck incorporating a rotating device with which loads are to be transported on or between receiving elements, particularly between two clamping jaws (15), which can be held in various orientations, characterised
in that the rotating device (30) is rotatable in both directions and by more than 180°,
in that a hydraulic fluid (31) is provided for the drive means for producing the rotary movement,
in that one or more cam members (40) are arranged on the rotating member of the rotating device (30),
in that one or more elements (41) are arranged on the fixed parts of the lift truck (10) or the attachment (14) opposite the rotating device (30) at those particular locations through which the cam member (40) or the cam members on the rotating device (30) pass shortly before the arrival thereof at the two vertical positions of the rotating device,
in that the cam members (40) thereby actuate the elements and in that a signal is produced by virtue of this actuation for cutting off the pressure exerted by the hydraulic fluid on the drive means in this direction of rotation.

2. A lift truck or an attachment in accordance with claim 1, characterised in that the rotating device is a 360° rotating device.

3. A lift truck or an attachment in accordance with claim 1 or 2, characterised in that the elements (41) are probes or projecting, depressible pins.

4. A lift truck or an attachment in accordance with any of the preceding claims, characterised in that the elements (41) are parts of a valve or of a plurality of valves which are directly actuated thereby.

5. A lift truck or an attachment in accordance with any of the preceding claims, characterised in that there is provided a switchable valve (45) which provides for selective switch-over to an undisturbed drive system that is not affected by the cam members (40) and the elements (41).

6. A lift truck or an attachment in accordance with claim 5, characterised in that the switchable valve (45) comprises two parallel pairs of passages, of which two passages convey the hydraulic fluid directly to the drive means for the rotational movement whereas the other two passages lead to lines that are affected by the elements (41), and wherein the switching of the valve (45) is effected between these two pairs of passages.

7. A lift truck or an attachment in accordance with claim 6, characterised in that, in the quiescent state, there is an automatic switch-over to the position which is affected by the elements (41).

8. A method of controlling a rotating device for a lift truck or an attachment for a lift truck incorporating a rotating device with which loads are to be transported on or between receiving elements, particularly between two clamping jaws (15), whereby said loads can be held in various orientations, characterised in that, in the course of a rotational movement of the rotating device, the pressure exerted by a hydraulic fluid on the drive means is cut-off shortly before arrival at a vertical position in this direction of rotation.

9. A method in accordance with claim 8, characterised in that this cut-off process is adapted to be overridden by manual intervention.
